(19) United States
(12) Patent Application Publication
(10) Pub. No.: US 2012/0244935 A1
(43) Pub. Date: Sep. 27, 2012

(54) SYNCHRONIZING GAME CHARACTER DISPLAY WITH GAME PLAYER VIEWING DETECTION

(75) Inventors: Erik J. Burckart, Raleigh, NC (US); Matthew L. Gauch, Raleigh, NC (US); Andrew Ivory, Wake Forest, NC (US); Aaron K. Shook, Raleigh, NC (US)

(73) Assignee: International Business Machines Corporation, Armonk, NY (US)

(21) Appl. No.: 13/070,795

(22) Filed: Mar. 24, 2011

(51) Int. Cl. A63F 13/00; A63F 13/06

(52) U.S. Cl. 463/30; 463/36

(57) ABSTRACT

Provided is a device for the display of the perspective associated with selected characters on a video display. A single player may be associated with multiple characters within the game, i.e. one player may be responsible for controlling multiple players. The disclosed technology modifies the displayed image so that the player views the game from the perspective of a particular game character determined by the eye gaze focus of the player.

### BACKGROUND OF THE INVENTION

The claimed subject matter relates generally to video game displays and, specifically, to techniques for synchronizing a game player's viewing with game character display.

In a multi-character video gaming scenario, a single player may control multiple characters. Currently, players are restricted to controlling the game with respect to a single character with no efficient means to shift focus from one character to another. In video games in which a single player controls multiple entities on the screen (e.g. an entire football team), the player may select an on-screen entity to control by scrolling through the available entities and selecting one. In real time games, the “next” entity selected may be automatically selected in a somewhat intelligent fashion by selecting the closest entity to another object, such as a game ball.

### SUMMARY

Provided are techniques for the synchronization of a game player's gaze with the display of characters on a video display. In a video game, a single player may be associated with multiple characters within the game. For example, one player may be responsible for controlling multiple players in a team sport such as basketball, hockey or football. Current gaming technologies do not allow a player to automatically change the perspective within the game to account for different possible actors among the characters within the game. Throughout the Specification, the term “player” is used to describe a person operating controls to affect the output of a game. The term “character” is used to describe one particular type of game element. For example, a player operates a game controller to control the actions of characters displayed within the game. Although described with respect to characters, the disclosed techniques are equally applicable to other game elements such as, but not limited to, machines, animals and so on. The disclosed techniques enable an active game controller (AGC) to detect a player's intention to shift from one character to another and change the focus accordingly.

One embodiment is a method comprising displaying a plurality of objects within a virtual environment associated with a video game; receiving data indicating a selection of an object of said plurality of objects in response to a detection of an occurrence of a first event of a first predetermined event type within gameplay of said video game, wherein said receiving comprises receiving data indicating an eye gaze focus area of a user interacting with said video game corresponding to said object, and said eye gaze focus area corresponds to said object; automatically selecting said object of said plurality of objects in response to said selection and an occurrence of a second event of a second predetermined event type within said gameplay of said video game.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is an illustration of one example of a gaming system architecture that may implement the claimed subject matter;

FIG. 2 is an illustration of one example of a video display that may be controlled in accordance with the disclosed technology;

FIG. 3 is a block diagram of an Active Game Controller (AGC), first introduced in FIG. 1, in more detail;

FIG. 4 is a flowchart of a Setup Viewing Control process that may implement aspects of the claimed subject matter; and

FIG. 5 is a flowchart of a Viewing Control process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

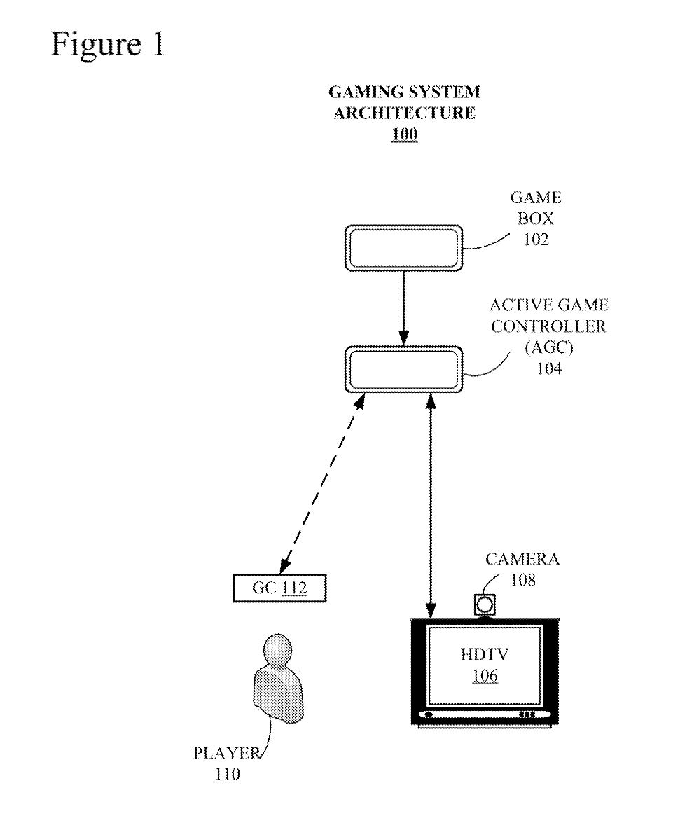

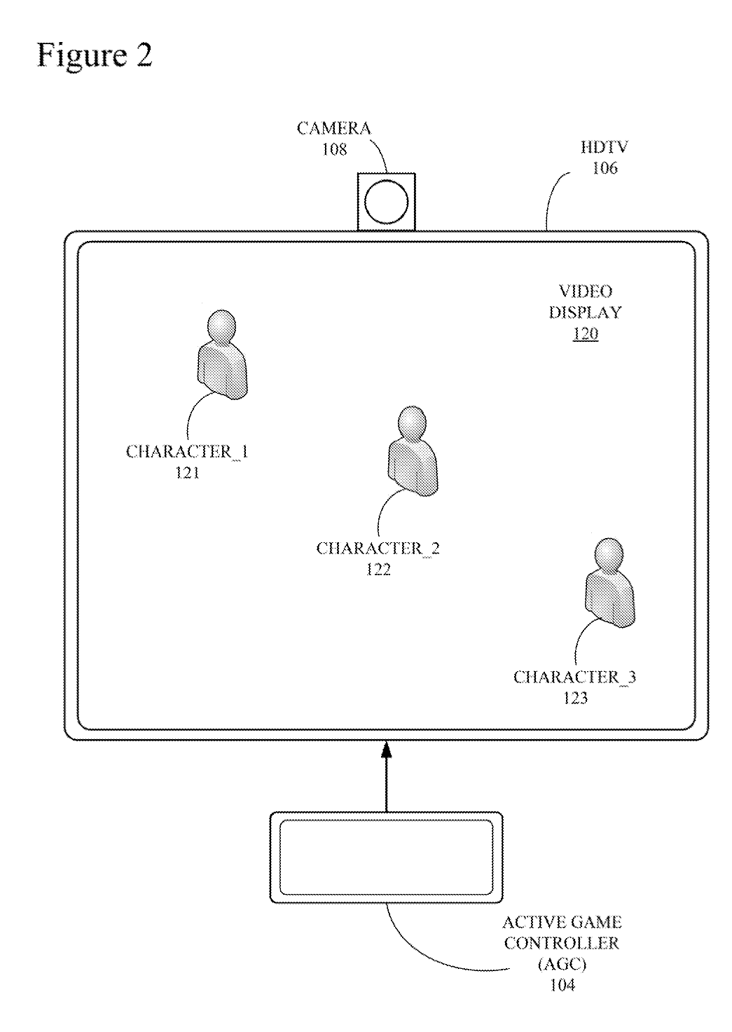

Turning now to the figures, FIG. 1 is an illustration of one example of a gaming system architecture 100 that may implement the claimed subject matter. Architecture 100 includes a high definition television (HDTV) 106 that may be any commercially available television. Of course HDTV 106 is only one example of a suitable display; the claimed subject matter may also be implemented in conjunction with a computer monitor, video projector or any display technology yet to be developed. HDTV 106 is coupled to an Active Game Controller (AGC) 104 that, in this example, implements the disclosed technology and is described in more detail below in conjunction with FIGS. 2-5.

A game box 102 provides a signal for HDTV 106 via AGC 104. A signal could also be supplied via a computer (not shown) or transmitted via a network such as the Internet. Those with skill in the relevant arts will appreciate the different methods by which video games are delivered and controlled. Coupled to HDTV 106 is a camera 108 that is employed to track user, i.e. a player 110, movement, including but not limited to eye movement. Player 110 controls AGC 104, and thereby the operation of a game executed by game box 102, by means of a game controller (GC) 112. A dotted line between AGC 104 and GC 112 indicates that, in this example, the connection is wireless, although the connection may also be a wired connection. Examples of type of wireless connections include, but are not limited to, infrared, radio frequency, DLP-Link and Bluetooth. The operation of AGC 104 with respect to game box 102, HDTV 106, camera 108, player 110 and game controller 112 and is explained in more detail below in conjunction with FIGS. 2-5.

FIG. 2 is an illustration of one example of a video display 120 that may be controlled in accordance with the disclosed technology. In this example, video display 120 is transmitted by AGC 104 (FIG. 1) based upon a signal received from game box 102 (FIG. 1) and projected by HDTV 106 for viewing by player 110 (FIG. 1). Within video display 120, three (3) game characters are displayed, i.e. a character_1 121, a character_2 122 and a character_3 123. In the following examples, characters 121-123 represent three (3) different team members in a particular team sport. For example, each of characters 121-123 may represent three potential receivers of a football that has been kicked by an opposing team.

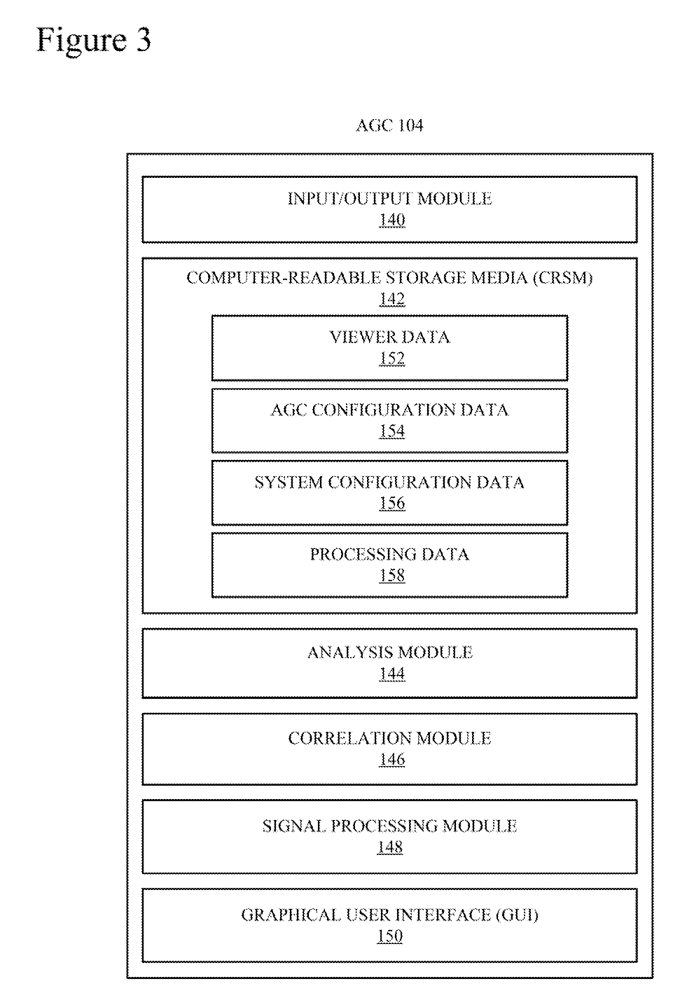

Also illustrated in FIG. 2 coupled to HDTV 106 is camera 108 (FIG. 1), which is employed to track movement, which in the following example is eye movement, of player 110 as player 110 operates GC 112 to control aspects of the game currently executing on game box 102. As explained in more detail below in conjunction with FIGS. 3-5, camera 108 is employed by AGC 104 to determine the current eye gaze focus of player 110 with respect to characters 121-123. In this manner, AGC 104 may transmit to video display 120 an image corresponding to the perspective of the particular character 121-123 on which player 110 is currently focusing.

FIG. 3 is a block diagram of AGC 104 first introduced in FIGS. 1 and 2 in more detail. AGC 104 includes an input/output (I/O) module 140, a computer-readable storage media (CRSM) 142, an analysis module 144, a correlation module 146, a signal processing module 148 and a graphical user interface (GUI) 150. For the sake of the following examples, AGC 104 is assumed to be a standalone component including logic associated with AGC 104 that is stored in conjunction with CRSM 142 and executed on a processor (not shown). In the alternative, AGC 104 may be incorporated into another suitable device, such as, but not limited to, HDTV 104 (FIGS. 1 and 2), game box 102 (FIGS. 1 and 2) or a computing system (not shown). Further, the representation of AGC 104 in FIG. 3 is a logical model. In other words, components 140, 142, 144, 146, 148 and 150 may be stored in the same or separates files and loaded and/or executed within system 100 either as a single system or as separate processes interacting via any available inter process communication (IPC) techniques.

I/O module 140 handles communication AGC 104 has with other components of system 100 (FIG. 1) such as, but not limited to, game box 102, HDTV 106, camera 108 (FIGS. 1 and 2) and GC 112. CRSM 142 is a data repository for information that AGC 104 requires during operation. Examples of the types of information stored in CRSM 142 include viewer data 152, AGC configuration data 154, system configuration data 156 and processing data 158.

Viewer data 152 stores information both on viewers such as player 110 (FIG. 1) that have accessed AGC 104 and established user profiles as well as default user profiles for viewers that have not established a profile. A user profile enables a user to establish personalized attributes with respect to the use of AGC 104. AGC configuration data 154 includes data on various configuration options for AGC 104. Examples of such options include, but are not limited to, a maximum number of characters that may be simultaneously be tracked and minimum requirements for an attached display device such as HDTV 106. System configuration data 156 stores information about system that AGC 104 may interact such as, but not limited to, game box 102, HDTV 106, camera 108 and GC 112. Processing data 158 stores information generated during operation of AGC 104 including intermediate processing results.

Analysis module 144 performs several functions including processing a signal received from, in this example, from game box 102 to identify potential characters, such as characters 121-123 (FIG. 2), and processing a signal from camera 108 to determine a position within video display 120 (FIG. 2) on which the gaze of player 110 (FIG. 1) is focused. Correlation module 146 determines which character 121-123 is the focus of player 110 by correlating the data related to characters 121-123 and eye focus processed in conjunction with analysis module 144. Signal processing module 148 processes the signal from game box 102 so that the display on video display 120 correlates with the perspective of the character 121-123 identified during processing associated with correlation module 146.

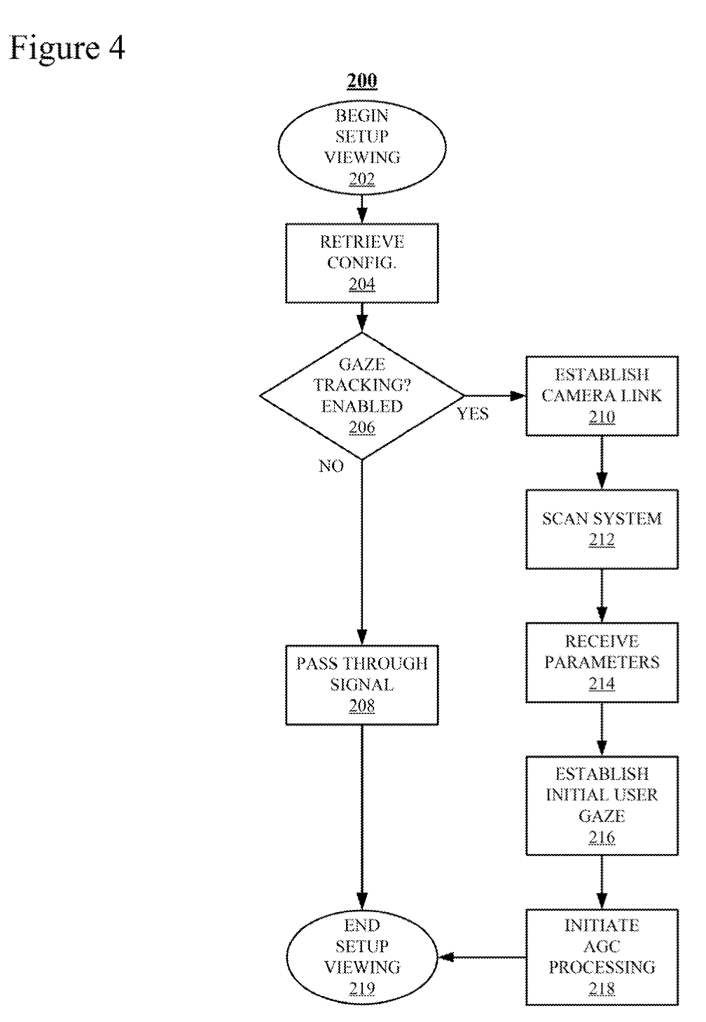

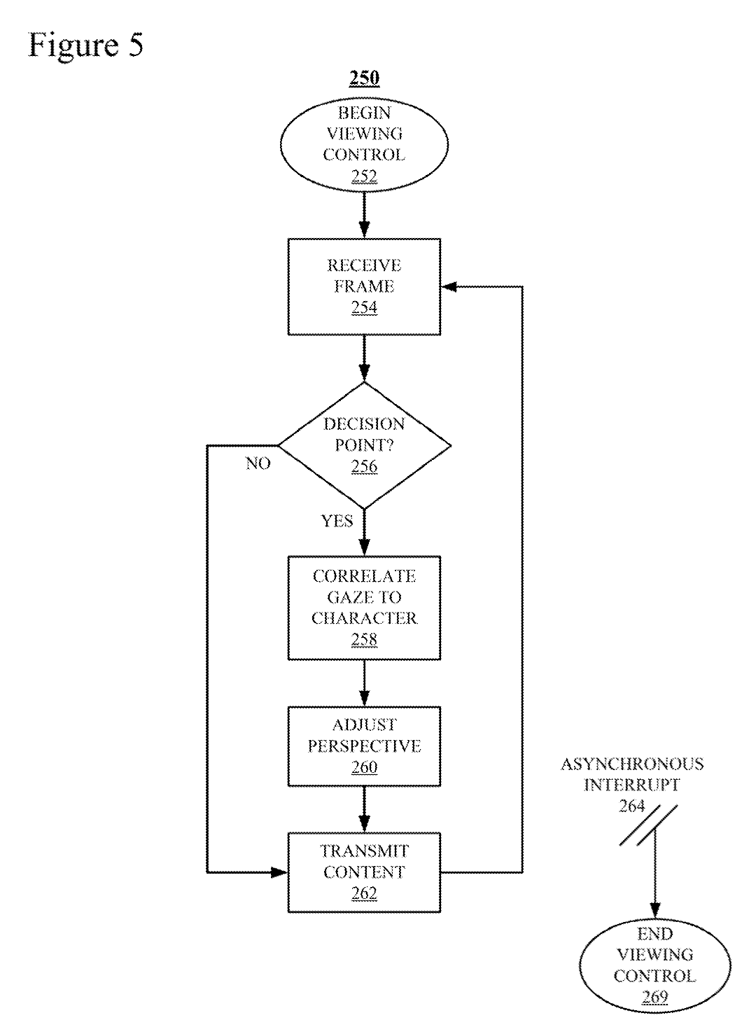

GUI 150 enables users of AGC 104 to interact with and to define the desired functionality of AGC 104, primarily by modifying information stored in data areas 152, 154 and 156 of CRSM 142. Components 142, 144, 146, 148, 150, 152, 154, 156 and 158 are described in more detail below in conjunction with FIGS. 4-5.

FIG. 4 is a flowchart of a Setup Viewing process 200 that may implement aspects of the claimed subject matter. In this example, process 200 is stored on CRSM 142 (FIG. 3) and executed on a processor (not shown) associated with AGC 104 (FIGS. 1-3) although, as explained above, the claimed functionality may be incorporated into another device such as game box 102 (FIGS. 1 and 2), HDTV 106 (FIGS. 1 and 2) or a computing system (not shown).

Process 200 starts in a “Begin Setup Viewing” block 202 and proceeds immediately to a “Process Configuration (Config.)” block 204. During processing associated with block 204, configuration parameters are received from AGC configuration data 154 (FIG. 3) of CRSM 142 (FIG. 3) and employed to configure AGC 104 with respect to user-defined preferences. As explained above in conjunction with FIG. 3, AGC configuration data 154 controls user selected options for the operation of AGC 104.

During processing associated with a “Gaze Tracking Enabled?” block 206, a determination is made as to whether or not system 100 is currently configured to implement the claimed subject matter and, if not, control proceeds to an “Pass Through Signal” block 208. During processing associated with block 208, AGC 104 is configured to transmit a signal from game box 102 to HDTV 106 unmodified, i.e. a game executing on game box 102 displays in the typical configuration for the particular game.

If, during processing associate with block 206, it is determined that AGC 104 is properly configured and the features are activated, control proceeds to and an “Establish Camera Link” block 210. During processing associated with block 210, a communication link is established between AGC 104 and camera 108 for receiving information on, in this example, eye position of player 110 (FIG. 1). During processing associated with a “Scan System” block 212, the types of devices that are coupled to AGC 104 for implementing the claimed subject matter are determined. During processing associated with a “Receive Parameters” block 214, the appropriate parameters for the devices determined during processing associated with block 212 are retrieved from CRSM 152 and AGC 104 is configured accordingly.

During processing associated with an “Establish Initial User Gaze” block 216, a determination is made from information transmitted from game box 102 based upon a signal from camera 108 as to what particular element of video display 120 (FIG. 2) player 110 (FIG. 1) is currently focusing. In other words, the eye gaze focus of player 110 is correlated with information related to displayed characters. During processing associated with an “Initiate AGC Processing” block 218, a Viewing Control process 250 (see FIG. 5) that implements the claimed techniques based upon the information collected and processed during process 200 is initiated. Finally, once processing associated with blocks 208 or 218 has been completed, control proceeds to an “End Setup Viewing” block 219 in which process 200 is complete.

FIG. 5 is a flowchart of a Viewing Control process 250 that may implement aspects of the claimed subject matter. Like process 200 (FIG. 4), process 250 is stored on CRSM 142 (FIG. 3) and executed on a processor (not show) as part of AGC 104 (FIGS. 1 and 3) in conjunction with a game display (see FIG. 2) on display 120 (FIG. 2) of HDTV 106 (FIGS. 1 and 2). Process 250 starts in a “Begin Viewing Control” block 252 and proceeds immediately to a “Receive Frame” block 254.

During processing associated with block 254, a video frame associated with game play is received from, in this example, game box 106 (FIG. 1). During processing associated with a “Decision Point?” block 256, a determination is made as to whether or not the frame received during block 254 represents a decision point in the game play. Two of many possible examples of game play decision points may include a point in the corresponding game when control of a game ball is in question such as during a kickoff during a football game or a jump ball during a basketball game. Detection of a decision point may be determined by techniques such as, but not limited to, signals within the game transmission from game box 102 or an analysis by AGC 104 of the ongoing process of the game (see 144, FIG. 3).

During processing associated with a “Correlate Gaze to Character” block 258, a signal from camera 108 (FIGS. 1 and 2) is analyzed (see 144, FIG. 3) to determine an eye gaze direction of player 110 (FIG. 1) with respect to display 120. This analysis is correlated (see 146, FIG. 3) with information on displayed characters (see 121-123, FIG. 2) in the frame received during block 254 to determine a particular character 121-123 that is the focus of the eye gaze focus of player 110. During processing associated with an “Adjust Perspective” block 260, the game play is modified to display the game from the perspective of the character 121-123 identified during processing associated with block 258. Such modification may be implemented by signaling game box 102, which would then make an appropriate modification to the game signal from game box 102 to AGC 104 or, in the alternative, by processing the signal to change perspective (see 148, FIG. 3). During processing associated with a “Transmit Content” block 262, a frame is transmitted to HDTV 106, typically the frame received during block 254. In an alternative embodiment AGC 104 may await a frame corresponding to a perspective altered during processing associated with block 260.

Finally, process 250 is halted by means of an asynchronous interrupt 264, which passes control to an “End Viewing Control” block 269 in which process 250 is complete. Interrupt 264 is typically generated when the corresponding game has concluded or as the result of a shutdown of AGC 104. During normal operation, process 250 continuously loops through the blocks 252, 254, 256, 258, 260 and 262 processing frames as they are received.

Two examples of game play in which the disclosed technology may be implemented include, but are not limited to, sports games and military scenarios. For example, in a football scenario, a first event may be a kickoff that is detected and determined to be a decision point. Data based upon an analysis of a player's eye gaze is received and analyzed to determine the player's eyes are focused on a particular object, e.g. a character, such as a specific receiver. A second event, e.g., the catching, or reception, of a football that was kicked during the kickoff, is then displayed such that the specific receiver receives the football and the game continues from the perspective of the specific receiver.

In another example corresponding to a military scenario involving two combat teams, e.g. a Team A and a Team B, a first event may be that members of Team A leave a particular waypoint. The player's eye gaze may then correspond to a member of Team B, who attempts to prevent the occurrence of a second event, e.g., the arrival of Team A at a second waypoint, such that the game proceeds from the perspective of the selected member of Team B.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method comprising:
displaying a plurality of objects within a virtual environment associated with a video game;
receiving data indicating a selection of an object of said plurality of objects in response to a detection of an occurrence of a first event of a first predetermined event type within gameplay of said video game, wherein said receiving comprises receiving data indicating an eye gaze focus area of a user interacting with said video game corresponding to said object, and said eye gaze focus area corresponds to said object;
automatically selecting said object of said plurality of objects in response to said selection and an occurrence of a second event of a second predetermined event type within said gameplay of said video game.

2. The method of claim 1, said selecting comprising proceeding with said gameplay from a perspective corresponding to said object.

3. The method of claim 1, further comprising transmitting a signal to a′ game device indicating a change in game perspective corresponding to the selecting of said object.

4. The method of claim 3, further comprising receiving a signal from the game device, wherein the signal received from the game device represents a game display from a perspective corresponding to the change in game perspective.

5. The method of claims 1, wherein said gameplay of said video game is based upon a competition between two teams, each team comprised of a corresponding plurality of characters.

6. The method of claim 5, wherein the second predetermined event type is a change in game control with respect to the two teams.

7. The method of claim 1, wherein said each object of the plurality of objects corresponds to a different character of a plurality of characters within said gameplay of said video game.

8. An apparatus comprising:
a processor;
a computer-readable storage medium coupled to the processor; and
logic, stored on the computer-readable storage medium and executed on the processor, for:
displaying a plurality of objects within a virtual environment associated with a video game;
receiving data indicating a selection of an object of said plurality of objects in response to a detection of an occurrence of a first event of a first predetermined event type within gameplay of said video game, wherein said receiving comprises receiving data indicating an eye gaze focus area of a user interacting with said video game corresponding to said object, and said eye gaze focus area corresponds to said object;
automatically selecting said object of said plurality of objects in response to said selection and an occurrence of a second event of a second predetermined event type within said gameplay of said video game.

9. The apparatus of claim 8, said logic for selecting comprising logic for proceeding with said gameplay from a perspective corresponding to said object.

10. The apparatus of claim 8, the logic further comprising logic for transmitting a signal to a game device indicating a change in game perspective corresponding to the selecting of said object.

11. The apparatus of claim 10, the logic further comprising logic for receiving a signal from the game device, wherein the signal received from the game device represents a game display from a perspective corresponding to the change in game perspective.

12. The apparatus of claims 8, wherein said gameplay of said video game is based upon a competition between two teams, each team comprised of a corresponding plurality of characters.

13. The apparatus of claim 12, wherein the second predetermined event type is a change in game control with respect to the two teams.

14. The apparatus of claim 8, wherein said each object of the plurality of objects corresponds to a different character of a plurality of characters within said gameplay of said video game.

15. A computer programming product comprising:
a computer-readable storage medium; and
logic, stored on the computer-readable storage media for execution on a processor, for:
displaying a plurality of objects within a virtual environment associated with a video game;
receiving data indicating a selection of an object of said plurality of objects in response to a detection of an occurrence of a first event of a first predetermined event type within gameplay of said video game, wherein said receiving comprises receiving data indicating an eye gaze focus area of a user interacting with said video game corresponding to said object, and said eye gaze focus area corresponds to said object;
automatically selecting said object of said plurality of objects in response to said selection and an occurrence of a second event of a second predetermined event type within said gameplay of said video game.

16. The computer programming product of claim 15, said logic for selecting comprising logic for proceeding with said gameplay from a perspective corresponding to said object.

17. The computer programming product of claim 15, the logic further comprising logic for transmitting a signal to a game device indicating a change in game perspective corresponding to the selecting of said object.

18. The computer programming product of claim 17, the logic further comprising logic for receiving a signal from the game device, wherein the signal received from the game device represents a game display from a perspective corresponding to the change in game perspective.

19. The computer programming product of claims 15, wherein said gameplay of said video game is based upon a competition between two teams, each team comprised of a corresponding plurality of characters.

20. The computer programming product of claim 19, wherein the second predetermined event type is a change in game control with respect to the two teams.
